(19) United States
(12) Patent Application Publication
(10) Pub. No.: US 2004/0216486 A1
(43) Pub. Date: Nov. 4, 2004

(54) Method for the production of a shaped silica glass body

(75) Inventors: Fritz Schwertfeger, Burghausen (DE); Holger Szillat, Emmerting (DE); Jan Tabellion, Riegelsberg (DE); Rolf Clasen, Saarbruecken (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 10/825,890

(22) Filed: Apr. 15, 2004

(30) Foreign Application Priority Data
Apr. 29, 2003 (DE) 103 19 300.6

(51) Int. Cl. C03B 8/02

(52) U.S. Cl. 65/17.2; 264/439; 204/450

(57) ABSTRACT

A method for the production of a homogenous, shaped SiO₂ body of near net shape wherein amorphous SiO₂ particles comprising relatively large amorphous SiO₂ particles and relatively small amorphous SiO₂ particles are electrophoretically deposited from an aqueous dispersion on an electrically nonconductive membrane, the shape and geometry of which correspond to the shaped SiO₂ body to be produced, wherein the membrane has an average pore size which is larger than the average particle size of the smaller amorphous SiO₂ particles.

### BACKGROUND OF THE INVENTION

1. Field of the Invention

The invention relates to a method for producing a shaped body made of amorphous SiO₂ with very high purity, in such a way as to obtain the correct final dimensions and contours, by electrophoretic deposition of amorphous SiO₂ particles from aqueous suspensions on a porous, electrically nonconductive membrane.

2. Background Art

From amorphous, porous shaped SiO₂ bodies it is possible to use sintering and/or fusion to produce highly pure, partially or fully densified shaped Si0₂ bodies which, for example, may be employed in the form of crucibles for pulling silicon single crystals or as preforms for glass fibers or optical fibers. Quartz articles of any type can also be produced in this way. Amorphous shaped SiO₂ bodies with a high porosity are useful in many technical fields. Examples which may be mentioned include filter materials, thermal insulation materials, and heat shields.

Regardless of the intended use of the shaped body, three basic requirements are demanded of the production method for such a shaped body. First, the shaped body should be made as close as possible to the correct final dimensions and contours, i.e. “near net-shape”, and second, the density of the unsintered shaped body should be maximized, coupled with excellent homogeneity. As a result, the sintering temperatures can be lowered, the effect of which, on the one hand, is that process costs are significantly reduced, while on the other hand, susceptibility to crystallization during sintering of the shaped SiO₂ body is significantly reduced. Lastly, the shaped body must have sufficient strength so as to permit industrial use or further processing.

Methods for producing shaped bodies made of SiO₂ are divided into dry and wet chemical methods. In the dry or pressing methods, binders generally need to be added in order to achieve sufficiently high densities and ensure satisfactory strength of the green body after shaping. These then need to be removed in a subsequent step, which is both technically difficult and expensive. A significant risk of introducing impurities into the shaped body also exists, which then prohibits the shaped body from being used, for example, for pulling silicon single crystals, for optical fibers, or other optical applications.

Wet chemical methods are therefore preferred way for preparing porous shaped SiO₂ bodies. One method known from the literature is the sol-gel process. This process generally begins with silicon-containing monomers dissolved in solvents (sol), which form a nanoporous three-dimensional SiO₂ network (gel) by means of hydrolysis and polycondensation. The porous shaped body is then obtained by drying. A disadvantage with this process is the expense of the starting materials. In addition, only gels with a solids content of about 10-20 wt. % can be obtained in this way. Such a shaped body has a very low strength and exhibits very pronounced shrinkage during subsequent sintering, which makes shaping to the correct final dimensions and contours impossible.

A method for obtaining shaped SiO₂ bodies with a low porosity is disclosed in EP 318100. In this method, a dispersion of highly disperse (“fumed”) silica in water is prepared. The thixotropy of the dispersion is utilized for shaping. A solids content of up to 60 wt. % is thereby obtained. The resulting 40 vol. % shrinkage makes shaping with the correct final dimensions and contours extremely difficult.

EP 0220774 discloses a method in which rotationally symmetric shaped SiO₂ bodies are produced by means of spin casting, using centrifugal forces, from a dispersion of highly disperse silica. Use of the method is restricted to rotationally symmetrical shaped bodies. EP 653381 and DE-A 2218766 disclose a slip casting method in which a dispersion of quartz glass particles with a particle size of from 0.45 to 70 μm in water is produced. The achievable solids content of the dispersion lies between 78 and 79 wt. %. The dispersion is subsequently solidified in a porous mold by extracting water, and dried after release from the mold. Although shaped bodies with a very high solids content can be produced by this method, which allows manufacture of shaped bodies with approximately the correct final dimensions, the method is very time-consuming owing to the diffusion-dependent water extraction, and is only applicable to thin-walled shaped parts.

EP 0196717 B1 discloses a pressure casting method in which shaped SiO₂ bodies are produced from an aqueous dispersion of highly disperse silica by means of elevated pressure in a porous mold. However, to control the rheological properties and in order to achieve sufficient strength of the shaped body after shaping, ionogenic additives need to be admixed. The concomitant purification of the green body in turn precludes use as, for example, crucibles for pulling silicon single crystals, optical fibers or optical components. The achievable densities of the shaped bodies, being about 50%, are also too low for shaping to approximately the correct final dimensions.

The shaping of dispersions with an extremely high fill factor has been proposed in order to achieve very high green densities, as described in DE 19943103 A1. This leads to greater problems in practice, however, since the disperse SiO₂ particles lead to a pronounced thixotropic effect which causes significant difficulties during processing.

Electrophoretic deposition is a wet chemical shaping method in which very high densities can be achieved even from suspensions with low fill factors. The term “electrophoretic deposition” means the movement and coagulation of electrically surface-charged dielectric particles in a dispersant in response to an applied static DC electric field. Owing to the surface charge of the particles with respect to the medium surrounding them, they move through the dispersant in the opposite direction to an applied potential difference. These particles can be deposited on an electrically conductive electrode (anode or cathode) charged oppositely to the surface charge of the particles, so that stable shaped bodies can be obtained. This process is preferably carried out in conjunction with organic dispersants, although these entail elaborate protective measures in order to eliminate toxic byproducts which can occur during the shaping and subsequent heat treatment. Furthermore, the disposal of organic dispersant is ecologically problematic.

Other problems occur in electrophoretic deposition from dispersions in water, as described for example in EP 0104903. For instance, water is electrolytically decomposed at a DC electrical voltage above about 1.5 V. Owing to the potential difference between the anode (+) and the cathode (−), migration of the hydrogen (H⁺) and hydroxyl ions (OH⁻) takes place towards the respective oppositely charged electrodes. The ions recombine there and hydrogen or oxygen gas is respectively formed, which sometimes leads to large irregular defects as gas inclusion in the shaped bodies. It is not therefore possible to use such shaped bodies on an industrial scale.

U.S. Pat. No. 2002/0152768 describes a method for producing bodies, in particular cup-shaped bodies, made of highly pure silica glass, by means of electrophoretic deposition. In this case, negatively charged SiO₂ particles are deposited from aqueous suspensions with a solids content of at least 80 percent by weight on an electrically conductive, positively charged electrode (anode). No measure is disclosed by which it is possible to prevent gas bubble inclusion in the shaped body due to the recombination of hydroxyl ions at the anode. Furthermore, the SiO₂ particles within the suspension must have a negative surface charge in order to induce deposition on the anode (positive charge). This is achieved through the use of additives which adjust the pH to between 6 and 9. The additives and the direct contact of the deposited shaped body with the graphite anode lead to contamination in the shaped bodies, which precludes the shaped bodies from being used as preforms for optical fibers and other optical components, or as crucibles for pulling silicon single crystals.

A method which addresses the problem of gas bubble formation is described in U.S. Pat. No. 5,194,129. The deposition takes place on a palladium electrode, which is capable of holding and storing hydrogen. This avoids gas bubbles and defects. This method, however, is limited by the finite hydrogen holding capacity of palladium, so that it is only possible to produce thin-walled shaped bodies. Furthermore, the contact of the shaped bodies with the palladium electrode again leads to contamination.

U.S. Pat. No. 3,882,010 discloses a method for the production of foundry crucibles by means of electrophoretic deposition from suspensions which contain refractory ceramic particles. That invention attempts to address the problem of gas bubble formation, due to recombination of ions at the deposition electrode, by firstly applying an electrically conductive layer of refractory particles and graphite (in the ratio 10:1) to a wax mold, on which electrophoretic deposition is subsequently carried out. The disclosure does not reveal the mechanism on the basis of which the incorporation of gas bubbles into the shaped bodies is thereby intended to be prevented. Furthermore, the method is very complicated and restricted to particular systems. It is not possible to produce highly pure shaped SiO₂ bodies in this way.

EP 0200242 and EP 0446999 B1 describe a method in which a shaped glass body is produced by electrophoretic deposition on a porous membrane and subsequent purification and sintering. The purification of the porous shaped glass body, which is necessitated because of contamination by additives that are admixed, constitutes an additional process step which is time intensive and therefore costly. The membranes used are characterized by having a pore size smaller than the average size of the particles to be deposited. When nanoscale particles are used as the starting material, it is therefore likewise necessary for the pores of the membranes employed to be nanoscale pores, which significantly restricts the choice of membrane materials. For instance, it is not possible to use porous plastic molds known to the skilled artisan for use in pressure casting, slip casting or capillary casting, since their average pore size is of the order of several hundred nanometers to 100 micrometres. Since there are currently no known geometrically stable membrane materials which, on the one hand, have a pore size smaller than 50 nanometers and, on the other hand, which introduce no contamination into the shaped silica glass bodies, as for example with plaster or clay molds, three-dimensionally shaped bodies made of highly pure silica glass cannot be produced using this method.

### SUMMARY OF THE INVENTION

It was an object of the invention to provide a method by which a homogeneous shaped SiO₂ body can be produced. These and other objects are achieved by employing amorphous SiO₂ particles comprising relatively large amorphous SiO₂ particles and relatively small amorphous SiO₂ particles, which are electrophoretically deposited from an aqueous dispersion on an electrically nonconductive membrane, the shape and geometry of which correspond to the shaped SiO₂ body to be produced, wherein the membrane has an average pore size which is larger than the average particle size of the smaller amorphous SiO₂ particles. The inventive method makes it possible to produce shaped bodies having open pores, with approximately the correct final dimensions and contours.

### BRIEF DESCRIPTION OF THE DRAWINGS

FIG. 1 shows the production of a crucible as described in Example 1.

FIG. 2 shows the production of a crucible as described in Example 2.

### DETAILED DESCRIPTION OF THE PREFERRED EMBODIMENT(S)

The electrophoretic deposition is carried out in a device in which an electrically nonconductive membrane, having an average pore size larger than the average particle size of the smaller amorphous SiO₂ particles, and shape and geometry which correspond to that desired for the shaped SiO₂ body to be produced, fitted between two electrically conductive electrodes, namely an anode (positive charge) and a cathode (negative charge). There is no electrical contact between the electrodes and the membrane in this case. The space between the anode and the membrane is filled with a dispersion made up of water and amorphous SiO₂ particles. The space between the membrane and the cathode is filled with a matching fluid. The SiO₂ particles in the dispersion are separated from the dispersant (water) by applying an electrical potential different (DC voltage) between the anode (positive) and the cathode (negative), and move away from the anode onto the electrically nonconductive membrane because of the electrophoretic driving force. The SiO₂ particles are deposited and compacted on the membrane, so that a wet shaped SiO₂ body having open pores is firstly formed there. This shaped body is subsequently detached from the membrane and dried. In a particular embodiment, the shaped body is firstly dried on the membrane and then detached from the membrane.

The electrically nonconductive membrane is preferably permeable to ions, so that cations and anions can migrate through the membrane, respectively toward the cathode or the anode, during the electrophoretic deposition. The inclusion of gas bubbles, which can be formed by recombination of the H⁺ and OH⁻ ions at the electrodes, is avoided owing to the spatial separation between the deposition on the membrane and the two electrodes.

For the deposition, it is preferable to use an electrically nonconductive membrane which has an open porosity of between 5 and 60 vol. %, preferably between 10 and 30 vol. %. The pore size of the membrane is larger than the average particle size of the smaller SiO₂ particles being used. A membrane with a pore size greater than 100 nanometers up to 100 micrometers, more preferably greater than 100 nanometers up to 50 micrometers, and most preferably between greater than 100 nanometers and 30 micrometers, is preferably used.

The membrane is electrically nonconductive and also has no semiconductor properties. It preferably has an electrical resistivity of more than 10⁸ Ωm, more preferably more than 10¹⁰ Ωm The membrane may be wetted with water. The contact angle between the membrane and water is generally less than 90°, preferably less than 80°. The membrane is thereby fully wetted with water, so as to obtain a constant profile of the electric field between the cathode and the anode, through the membrane, during the electrolytic deposition.

Any plastic known to those skilled in the art, which is chemically stable and contains no substantial quantities of free residues, in particular no metallic residues, is suitable as a material for the membrane. Plastics which are used in commercial pressure slip casting are especially suitable, while polymethacrylates and polymethylmethacrylates are particularly preferred.

The thickness of the membrane is dictated by the shape of the shaped article to be produced. The thickness of the membrane should preferably be selected so that this shape can be produced accurately by the membrane and is furthermore geometrically stable while the method according to the invention is being carried out. It should preferably be no thicker than is necessary in order to satisfy the aforementioned criteria, since otherwise the electric field would be unnecessarily attenuated during the electrophoresis according to the invention, which would detrimentally affect the electrophoretic deposition.

Electrically conductive and chemically stable materials may be used as the electrodes. It is furthermore possible to use materials which are coated with electrically conductive, chemically stable materials. The electrodes may be used in a bulk form or in a networked form.

Electrically conductive plastics, graphite, tungsten, tantalum or noble metals are preferred electrode materials. Tungsten, tantalum or platinum are particularly preferred. The electrodes may, however, also consist of alloys and/or be coated with the aforementioned materials. Such a choice of the electrode material prevents the deposited shaped body from being contaminated by atomic impurities, in particular by metal atoms from the electrodes.

Water is preferably used as the dispersant. It is particularly preferable to use highly pure water which has a resistivity >18 megohm·cm.

SiO₂ particles with a round and compact morphology are preferably used as the amorphous SiO₂ particles. The specific density of the SiO₂ particles should generally lie between 1.0 and 2.2 g/cm³. It is preferable for the particles to have a specific density of between 1.8 g/cm³ and 2.2 g/cm³, more preferably between 2.0 g/cm³ and 2.2 g/cm³. SiO₂ particles with ≦3 OH groups per nm² on their outer surface, more preferably ≦2 OH groups per nm², and more most preferably ≦1 OH groups per nm², are preferred. The amorphous SiO₂ particles preferably have a crystalline fraction of at most 1%. They should also preferably exhibit minimal interaction with the dispersant.

The amorphous SiO₂ particles are present in a multimodal distribution with at least two different average particle sizes. The larger amorphous SiO₂ particles should have a particle size distribution with a D50 value of between 1 and 200 μm, preferably between 1 and 100 μm, more preferably between 10 and 50 μm, and most preferably between 10 and 30 μm. A particle size distribution which is as narrow as possible is furthermore advantageous. Amorphous SiO₂ particles with a BET surface area of from 0.001 m²/g to 50 m²/g, more preferably from 0.001 m²/g to 5 m²/g, and most preferably from 0.01 m²/g to 0.5 m²/g, are preferred.

Amorphous SiO₂ particles from various sources have these properties, for example fused (re-sintered) silica and any type of amorphous sintered or compacted SiO₂. These are therefore preferable for producing the dispersion according to the invention. Other useful materials can be produced in a manner which is known per se in an oxyhydrogen flame, such as those commercially available, for example under the tradename Exelica® from Tokoyama, Japan.

If the aforementioned criteria are satisfied, it is also possible to use particles from other sources, for example natural quartz, quartz glass sand, vitreous silica, ground quartz glasses or ground quartz glass waste, as well as chemically produced silica glass, for example precipitated silica, highly disperse (fumed) silicas (produced by means of flame pyrolysis), xerogels or aerogels.

The amorphous SiO₂ particles are preferably precipitated silicas, highly disperse silicas, fused silica or compacted SiO₂ particles, more preferably highly disperse silica or fused silica, and most preferably fused silica. Mixtures of various SiO₂ particles are likewise possible and preferred.

The small SiO₂ particles are preferably fumed or fused silicas with a particle size of 1-100 nm, preferably from 10 to 50 nm. These SiO₂ particles preferably have a BET specific surface of from 10 m²/g to 400 m²/g, more preferably from 50 m²/g to 400 m²/g. Highly disperse (fumed) silicas produced by flame pyrolysis have these properties, for example, and are available, under the tradenames HDK® (Wacker-Chemie), Cabo-Sil® (Cabot Corp.) or Aerosil® (Degussa). These nanoscale SiO₂ particles function as a kind of inorganic binder between the substantially larger SiO₂ particles, but not as a filler material to achieve a higher fill factor. Such small SiO₂ particles preferably have a bimodal particle size distribution in the dispersant.

With respect to the total amount of amorphous SiO₂ particles, the smaller amorphous SiO₂ particles are preferably present in an amount of from 0.1 to 50 wt. %, more preferably in an amount of from 1 to 30 wt. %, and most preferably in an amount of from 1 to 10 wt. %, the remainder to 100 wt. % being formed by the larger amorphous SiO₂ particles. In a preferred embodiment, the amorphous SiO₂ particles are present in a highly pure form, i.e. with a proportion of atomic impurities, in particular metals, ≦300 ppm (parts per million by weight), preferably ≦100 ppm, more preferably ≦10 ppm, and most preferably ≦1 ppm.

Since the speed of the movement of electrically surface-charged particles due to electrophoresis as a driving force is not affected by the particle size, dispersions of water and SiO₂ particles with a monomodal particle size distribution can also be deposited very uniformly to form a very homogeneous shaped body having open pores, without the particles becoming separated according to their size. Such separation is, however, observed in other wet chemical methods.

The SiO₂ particles are dispersed in water in a manner which is known per se. Any methods known to the person skilled in the art may be used for this. The fill factor of the dispersions lies between 10 and 80 wt. %, preferably between 30 and 70 wt. % and most preferably between 50 and 70 wt. %. Owing to the comparatively low fill factor, the amorphous SiO₂ particles can be dispersed well, thixotropy plays only a subordinate role, and the dispersions are readily processable. The rheological properties can also be adjusted and controlled reproducibly. The viscosity of the dispersions advantageously lies between 1 and 1000 mPa·s, preferably between 1 and 100 mPa·s.

The pH of the dispersions lies between 3 and 9, preferably between 3 and 7, and more preferably between 3 and 5. The electrical conductivity lies between 0.1 and 10,000 μS/cm, preferably between 1 and 100 μS/cm. The zeta potential preferably lies between −10 and −80 mV.

Bases, particularly mineral bases may be added to the dispersion in a further embodiment, these bases preferably being volatile substances with no contaminating metal components, in particular ammonium compounds such as tetramethylammonium hydroxide (TMAH) or ammonia, or mixtures thereof. A pH of between 9 and 13, preferably between 10 and 12, may be established in this way. A zeta potential of between −10 and −70 mV, preferably between −30 in −70 mV, is likewise possible.

Water is used as a matching fluid between the membrane and the anode. It is preferable to use highly pure water which has a resistivity≧18 megohm·cm.

In a further embodiment, mineral or organic acids, such as HCl, H₂SO₄, silicic acid, acetic acid or formic acid, or bases, especially ammonium compounds such as tetramethylammonium hydroxide (TMAH) or NH₃, or mixtures thereof, are added to the matching fluid. It is furthermore possible to admix ionogenic additives. Volatile substances which do not form any metal ions upon dissociation are particularly preferred. The electrical conductivity of the matching fluid therefore preferably lies between 0.1 and 100,000 μS/cm, preferably between 0.1 and 10,000 μS/cm.

A DC electrical voltage of between 5 and 500 V, preferably between 30 and 300 V, is applied between the anode (positive charge) and the cathode (negative charge). The electric field strength lies between 1 and 100 V/cm, preferably between 5 and 50 V/cm.

The duration of the deposition depends essentially on the selected body thickness. In principle it is possible to produce any body thickness. Body thicknesses of between 1 and 50 mm, preferably between 5 and 30 mm, and more preferably between 5 and 20 mm, are preferably deposited. The deposition rate lies between 0.1 and 2 mm per minute, preferably between 0.5 and 2 mm per minute.

The shaped body having open pores which is deposited in this way can be detached from the membrane using methods known to the person skilled in the art. The deposited shaped body is preferably detached from the membrane by pressurized air, which is blown through the pores of the membrane from the opposite side of the membrane to the shaped body. In a similar way, the shaped body may be detached by means of water.

In a special embodiment, the shaped body is detached from the membrane by leaving the membrane with the shaped body deposited on it between the electrodes, filling the entire space between the electrodes and the shaped body, or the membrane, with water, preferably highly pure water, and applying DC electrical voltage between the electrodes, the sign of the DC electrical voltage being opposite to the sign of the voltage which was applied for the electrophoretic deposition. By means of an electro-osmotic flow, a layer of water is formed at the interface between the shaped body and membrane and the shaped body is detached from the membrane.

The shaped body having open pores which is obtained is subsequently dried. The drying is carried out by means of the methods known to the person skilled in the art, for example vacuum drying, drying by means of hot gases, for example nitrogen or air, contact drying or microwave drying. A combination of the individual drying methods is also possible. Drying by means of microwaves is preferred. The drying is preferably carried out at temperatures in the shaped body of between 25° C. and the boiling point of the dispersant (water) in the pores of the shaped body. The drying times depend on the volume of the shaped body to be dried, the maximum layer thickness and the pore structure of the shaped body.

Minor shrinkage takes place when the shaped body is dried. The shrinkage depends on the fill factor of the wet shaped body. For a fill factor of 80 wt. %, the volume shrinkage is ≦2.5% and the linear shrinkage ≦0.8%. The shrinkage is less with a higher fill factor.

In a particular embodiment, in which all the steps are carried out using highly pure materials, the shaped body has a proportion of atomic impurities, in particular metals, ≦300 ppm, preferably ≦100 ppm, more preferably ≦10 ppm, and most preferably ≦1 ppm.

The shaped body which can be obtained in this way is an amorphous shaped SiO₂ body having open pores and approximately the correct final contours, with any desired size and configuration.

The shaped bodies are ones which consist of SiO₂ particles to at least 64 vol. %, preferably to at least 70 vol. %, and have a pore volume (determined by means of mercury porosimetry) of from 1 ml/g to 0.01 ml/g, preferably from 0.8 ml/g to 0.1 ml/g and most preferably from 0.4 ml/g to 0.1 ml/g, and which have pores with a pore diameter of from 1 to 10 μm, preferably from 3 to 6 μm which are stable when sintered at up to 1000° C., or pores with a bimodal pore diameter distribution, one pore diameter maximum being in the range of from 0.01 μm to 0.05 μm, preferably from 0.018 μm to 0.0022 μm, and a second pore diameter maximum being in the range of from 1 μm to 5 μm, more preferably from 1.8 μm to 2.2 μm.

Shaped bodies according to the invention may furthermore have a monomodal pore diameter distribution, the pore diameter lying in the range of from 2.2 μm to 5.5 μm, preferably from 3.5 μm to 4.5 μm, and the internal surface area of the shaped body being from 100 m²/g to 0.1 m²/g, preferably from 50 m²/g to 0.1 m²/g. Such a shaped body is obtained when a shaped body having pores with a bimodal pore diameter distribution as mentioned above is heated to 1000° C.

The shaped bodies according to the invention are preferably stable with respect to their volume when sintered at up to 1000° C.

When small amounts (about 1 to 4 wt. %) of particles in the nanometer range are used for producing a dispersion according to the invention, the shaped body production method according to the invention can be used to produce shaped bodies from the dispersion which have a monomodal pore distribution in a size range of from 1 μm to 10 μm, preferably from 3 μm to 6 μm, the use of larger particles in the dispersion leading to larger pores in the shaped body, and a narrow particle size distribution in the dispersion leading to a narrow pore size distribution in the shaped body. The addition of larger amounts (about 5 to 50 wt. %) of particles in the nanometer range leads to a bimodal pore size distribution in the shaped body, which also contains pores in the sub-nanometer range besides said pores. The overall fill factor of the shaped body is unchanged in all such cases.

The density of the shaped body produced according to the invention lies between 1.4 g/cm³ and 1.8 g/cm³.

The described shaped bodies with a monomodal pore distribution are stable when sintered at up to 1000° C. for at least 24 hours. They are furthermore thermally stable and have a very low thermal expansion coefficient.

Owing to their special properties, the described shaped bodies can be used in a wide variety of ways, for example as filter materials, thermal insulation materials, heat shields, catalyst support materials, and as “preforms” for glass fibers, optical fibers, optical glasses or quartz articles of any type.

In another special embodiment, a very wide variety of molecules, materials and substances may be fully or partially added to the shaped bodies having open pores. Molecules, materials and substances that are catalytically active are preferred. All methods known to the person skilled in the art may be used, some of which are described, for example, in U.S. Pat. No. 5,655,046. In another special embodiment, it is possible for molecules, materials and substances that provide the respective shaped bodies with additional properties may be added to the dispersions and/or the shaped bodies having open pores.

In a particular embodiment, compounds which promote or cause cristobalite formation may be fully or partially added to the dispersion and/or the shaped bodies. All compounds known to the person skilled in the art which promote and/or cause cristobalite formation may be used, as described for example in DE 10156137. BaOH and/or aluminum compounds are preferred in this case.

After such a shaped body is sintered, crucibles for the crystal pulling of Si single crystals, which have a cristobalite layer on the inside and/or outside, or consist entirely of cristobalite, are in particular obtained. These crucibles are particularly suitable for crystal pulling since they are thermally stable and, for example, contaminate a silicon melt to a lesser extent. Higher yields can thereby be achieved during crystal pulling.

In a special embodiment, the shaped bodies may be subjected to further sintering. All methods known to the person skilled in the art may be used, for example vacuum sintering, zonesintering, arc discharge sintering, plasma or laser sintering, inductive sintering or sintering in a gas atmosphere or gas stream. Sintering in a vacuum or gas stream as described in EP-A-1210294 is preferred.

The shaped bodies may also be sintered in special atmospheres, for example He or SiF₄, in order to achieve re-purification and/or enrichment of particular atoms and molecules in the sintered article. All methods known to the person skilled in the art may be used, as described for example in U.S. Pat. No. 4,979,971. All methods may also be used for re-purification, as described for example in EP 199787.

Sintering by means of CO₂ lasers is also preferred, as described in detail in Applications DE 10158521 A and DE 10260320 A by the same Assignee. In this way it is possible to produce a 100% amorphous (no cristobalite) sintered shaped silica glass body which is transparent, impermeable to gases and has a density of at least 2.15 g/cm³, preferably 2.2 g/cm³.

In one preferred embodiment, the sintered shaped silicon glass body has no gas inclusions and preferably an OH group concentration ≦1 ppm. In another preferred embodiment, in which all the steps are carried out using highly pure materials, the sintered shaped body has a proportion of atomic impurities, in particular metals, ≦300 ppm, preferably ≦100 ppm, more preferably ≦10 ppm and most preferably ≦1 ppm.

The sintered shaped silicon glass bodies produced in this way are suitable for all applications in which silica glass is used. Preferred fields of application are quartz articles of any type, glass fibers, optical fibers and optical glasses. Highly pure silica glass crucibles for pulling silicon single crystals are a particularly preferred area of application.

The following examples will serve to explain the invention further.

### EXAMPLE 1

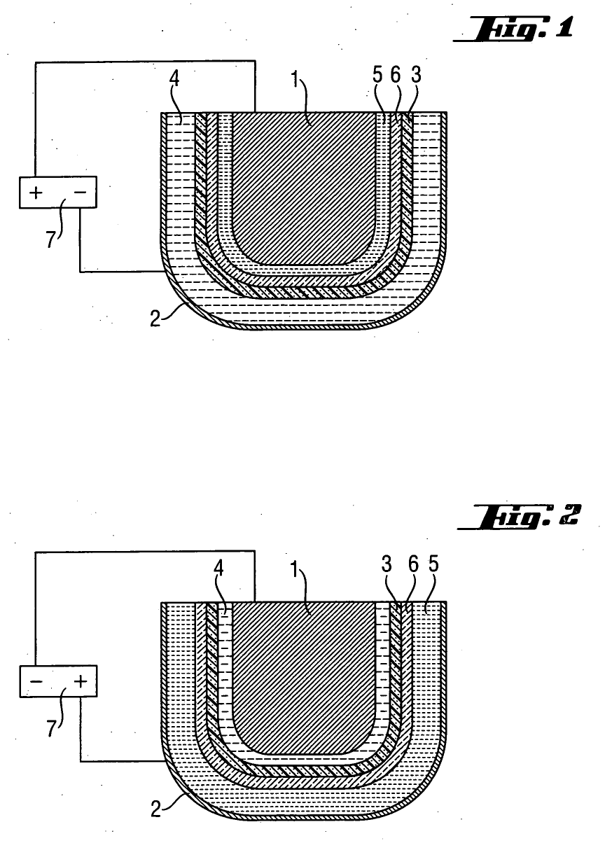

A 14″ crucible is deposited on the inside of a plastic membrane by means of electrophoresis, with reference to FIG. 1. The anode (1) made of aluminum (coated with platinum) is connected to the anode of the voltage source (7). The plastic membrane (3) consists of methyl methacrylate with 40 μm large pore radii and an open porosity of 20 vol. %. The SiO₂ dispersion (5) consists of 5 wt. % fumed silica, 70 wt. % fused silica and 25 wt. % highly pure water. It is located between the anode (1) and the membrane (3). The matching fluid (4) is adjusted to a conductivity of 7000 μS/cm using a TMAH electrolyte and is located between the membrane and the cathode (2). The cathode (2) made of aluminum (coated with platinum) is connected to the cathode of the voltage source (7).

With a field density of 15 V/cm, a crucible (6) with a body thickness of 10 mm is deposited in 5 min from the dispersion on the side facing the anode (inside) of the membrane. After the crucible has been deposited, the dispersion is removed and replaced by the matching fluid. The crucible is subsequently detached from the membrane by a 20 second reversal of the electric field.

### EXAMPLE 2

A 14″ crucible is deposited on the outside of a plastic membrane by means of electrophoresis, with reference to FIG. 2.

The cathode (1) made of aluminum (coated with platinum) is connected to the cathode of the voltage source (7). The plastic membrane (3) consists of methyl methacrylate with 40 μm large pore radii and an open porosity of 20 vol. %. The SiO₂ dispersion (5) consists of 5 wt. % fumed silica, 70 wt. % fused silica and 25 wt. % highly pure water. It is located between the anode (2) and the membrane (3). The matching fluid (4) is adjusted to a conductivity of 7000 μS/cm using a TMAH electrolyte and is located between the membrane and the cathode (1). The anode (2) made of aluminum (coated with platinum) is connected to the anode of the voltage source (7).

With a field density of 15 V/cm, the crucible (6) is deposited with a body thickness of 10 mm in 5 min from the dispersion on the outside of the membrane. After the crucible has been deposited, the dispersion is removed and replaced by the matching fluid. The crucible is subsequently detached from the membrane by a 20 second reversal of the electric field.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for the production of a homogenous, shaped SiO₂ body of near net shape, wherein an at least bimodal dispersion of amorphous SiO₂ particles comprising a first population of amorphous SiO₂ particles of a first average particle size and a second population of amorphous SiO₂ particles having an average particle size less than the average particle size of said first population, are electrophoretically deposited from an aqueous dispersion on an electrically nonconductive membrane whose shape and geometry correspond to the shape and geometry of the SiO₂ body to be produced, wherein the membrane has an average pore size which is larger than the average particle size of the second population of amorphous SiO₂ particles.

2. The method of claim 1, wherein said electrically nonconductive membrane is positioned between two electrically conductive electrodes, an anode and a cathode, there being no direct electrical contact between the electrodes and the membrane, the space between the anode and the membrane being filled with a dispersion made up of water and amorphous SiO₂ particles, and the space between the membrane and the cathode being filled with a matching fluid, wherein the SiO₂ particles in the dispersion are separated from the dispersant (water) by applying an electrical potential difference between the anode and the cathode, and move away from the anode onto the electrically nonconductive membrane because of the electrophoretic driving force, and are deposited and compacted on the membrane, so that a wet shaped SiO₂ body having open pores is formed there, and this shaped body is subsequently detached from the membrane and dried, or is first dried and then detached from the membrane.

3. The method of claim 1, wherein the electrically nonconductive membrane is permeable to ions.

4. The method of claim 1, wherein the electrically nonconductive membrane has an open porosity of between 5 and 60 vol. %.

5. The method of claim 1, wherein the electrically nonconductive membrane has an open porosity of between 10 and 30 vol. %.

6. The method of claim 1, wherein the membrane has an average pore size greater than 100 nanometers and up to about 100 micrometers.

7. The method of claim 1, wherein the membrane has an average pore size greater than 100 nanometers and up to about 50 micrometers.

8. The method of claim 1, wherein the membrane has an average pore size greater than 100 nanometers and up to about 30 micrometers.

9. The method of claim 1, wherein the membrane has an electrical resistivity of more than 10⁸ Ωm.

10. The method of claim 1, wherein the membrane has an electrical resistivity of more than 10¹⁰ Ωm.

11. The method of claim 1, wherein the membrane contains no free residues.

12. The method of claim 1, wherein the SiO₂ particles in the dispersion have a bimodal particle size distribution.

13. The method of claim 1, wherein the dispersant comprises water.

14. A body having open pores, prepared according to the method of claim 1, which comprises at least 64 vol. % SiO₂ particles, has a pore volume determined by means of mercury porosimetry of from 1 ml/g to 0.01 ml/g, which has pores with an average pore diameter of from 1 to 10 μm, which are stable when sintered at up to 1000° C., or which has pores with a bimodal pore diameter distribution, one pore diameter maximum being in the range of from 0.01 μm to 0.05 μm, and a second pore diameter maximum being in the range of from 1 μm to 5 μm.

15. A body having open pores, prepared according to the method of claim 1, which comprises at least 70 vol. % SiO₂ particles, and has a pore volume determined by means of mercury porosimetry of from 0.8 ml/g to 0.1 ml/g and which has pores with an average pore diameter of from 3 to 6 μm which are stable when sintered at up to 1000° C., or which has pores with a bimodal pore diameter distribution, one pore diameter maximum being in the range of from 0.018 μm to 0.0022 μm, and a second pore diameter maximum being in the range of from 1.8 μm to 2.2 μm.

16. A sintered shaped silica glass body prepared by sintering the shaped body of claim 14 which is substantially 100% amorphous, transparent, impermeable to gases and has a density of at least 2.15 g/cm³.

17. A sintered shaped silica glass body prepared by sintering the shaped body of claim 14 which is substantially 100% amorphous, transparent, impermeable to gases and has a density of at least 2.2 g/cm³.

18. The shaped silica glass body of claim 16, which has substantially no gas inclusions and optionally an OH group concentration ≦1 ppm.

19. The shaped silica glass body of claim 16, which has a proportion of atomic impurities, ≦300 ppm, preferably ≦100 ppm, more preferably ≦10 ppm and most preferably ≦1 ppm.

20. A silica glass crucible suitable for pulling a silicon single crystal, prepared by the method of claim 1.
